(19) United States
(12) Patent Application Publication
(10) Pub. No.: US 2005/0049849 A1
(43) Pub. Date: Mar. 3, 2005

(54) Cross-platform virtual tape device emulation

(76) Inventors: Vincent Re, St. James, NY (US); Daniel Mooney, Center Moriches, NY (US)

Correspondence Address: COOPER & DUNHAM, LLP, 1185 AVENUE OF THE AMERICAS, NEW YORK, NY, 10036, US

(21) Appl. No.: 10/851,621

(22) Filed: May 21, 2004

Related U.S. Application Data
(60) Provisional application No. 60/473,322, filed on May 23, 2003.

(51) Int. Cl. G06F 9/455

(52) U.S. Cl. 703/26

(57) ABSTRACT

An apparatus and a method for facilitating tape access from non-mainframe platform software applications to mainframe tape hardware are provided. A tape access request in a non-mainframe format from a non-mainframe application is mapped through an emulation layer to a neutral format request. The neutral format request is converted to an equivalent mainframe format command for accessing a mainframe tape device.

### CROSS-REFERENCE TO RELATED APPLICATIONS

This application claims the benefit of commonly assigned provisional application Ser. No. 60/473,322, filed May 23, 2003 and entitled “CROSS-PLATFORM VIRTUAL TAPE DEVICE EMULATION”, which is incorporated in its entirety herein by reference.

### TECHNICAL FIELD

This application relates to access of computer tape devices. In particular, the application relates to integration of mainframe and non-mainframe tape technologies.

### DESCRIPTION OF RELATED ART

Many large, organizations (such as enterprises) today are concerned about protecting and backing up information across complex, heterogeneous computing networks. Typically, terabytes of data are dispersed across a variety of (often incompatible) computer systems that range from desktop personal computers to large mainframe computers. A large selection of tape application software are available for backup of data to tape media and managing data stored on the tape media.

Tape applications typically are sophisticated, low-level programs that maintain low-level control of tape hardware devices. In many instances, low-level control (such as during backup of tape devices) in mixed platform environments can be difficult to achieve because of incompatibilities and performance issues with different tape technologies, such as mainframe and SCSI (Small Computer Serial Interface) tape technologies.

Mainframe and SCSI tapes are traditionally very different in low-level operation, owing to the wide gap in capabilities between SCSI and mainframe (for example, ESCON, FICON, etc.) channel protocols.

Tape applications in a mainframe environment generally require low-level, primitive control of tape devices using a much more intricate set of programming interfaces. For example, tape applications commonly control mounting and positioning of the physical tape, and are very careful to provide for the wide range of hardware status conditions that can affect reading or writing tape volumes.

Frequently, large enterprises have major investments in tape technologies and expertise on mainframe computers. It has been difficult and inefficient to use conventional technologies to leverage mainframe tape technologies for backing up data from non-mainframe computing platforms. With the introduction of the Linux operating system on mainframe computers, the lack of integration has become even more apparent. For example, traditional mainframe workloads and Linux applications frequently are run on the very same computers, and this intensifies the need for the ability to exploit mainframe tape technology across platforms.

In addition, distributed file system technologies in a non-mainframe environment permit remote access to computer files in a network. Distributed file systems typically are based on an abstraction of disk file system semantics, which are easier to virtualize over networks. However, the disk file system abstraction is quite different from a mainframe tape device abstraction, and therefore conventional distributed file system technologies are not easily extendible for a mainframe environment.

New technologies are needed to leverage existing mainframe tape-devices and operational procedures.

### SUMMARY

The application provides an apparatus for facilitating tape access from non-mainframe platform software applications to mainframe tape hardware. In one embodiment, the apparatus includes an emulation layer and a tape request processing component. The emulation layer provides an interface to a non-mainframe application, and maps a tape access request in a non-mainframe format received through the interface to a neutral format. The tape request processing component receives the neutral format request from the client, and converts the neutral format request from the client to an equivalent mainframe format command for accessing a mainframe tape device.

The application also provides a method for facilitating tape access from non-mainframe platform software applications to mainframe tape hardware. In one embodiment, the method includes mapping through an emulation layer a tape access request in a non-mainframe format from a non-mainframe application to a neutral format request, and converting the neutral format request to an equivalent mainframe format command for accessing a mainframe tape device.

### BRIEF DESCRIPTION OF THE DRAWINGS

The features of the present application can be more readily understood from the following detailed description with reference to the accompanying drawings wherein:

FIG. 1 shows a block diagram of an apparatus for facilitating tape access from non-mainframe platform software applications to mainframe tape-hardware, according to one embodiment of the present application:

FIG. 2 shows a flow chart of a method for facilitating tape access from non-mainframe platform software applications to mainframe tape hardware, according to one embodiment; and

FIG. 3 shows a block diagram of a system for facilitating tape access from non-mainframe platform software applications to mainframe tape hardware, according to one embodiment of the present application.

### DETAILED DESCRIPTION

Some tape applications may originally be designed for platforms on which non-mainframe format (such as SCSI) tape devices are the only available option. When the tape applications are used in a mainframe or mixed environment, a need to support new tape devices (locally and/or remotely) may arise and therefore it is desirable to provide the required device support without substantial changes to the tape application.

A non-mainframe tape backup application in some instances may need to be adapted to communicate with a server on a mainframe in order to access mainframe tape devices, with the mainframe handling all tape input/output. However, substantial changes to the client side of the backup application are typically required, essentially inserting a whole new client-server layer.

Another possibility is to require hardware compatible with mainframe tape devices on the client platform. Although mainframe-compatible hardware allows the client to directly operate the mainframe tape device, it leads to several restrictions, such as requiring expensive hardware that is not universally available on all platforms. In addition, mainframe-compatible hardware is not necessarily and is not automatically integrated with existing mainframe tape management software. Furthermore, addition of mainframe-compatible hardware does not provide scalability beyond a small number of systems, and may easily interfere with existing mainframe tape applications.

This application provides tools (in the form of methods, apparatuses and systems) for facilitating tape access from non-mainframe platform tape application software to mainframe tape hardware. The tools may be embodied in one or more computer programs stored on a computer readable medium and/or transmitted via a computer network or other transmission medium.

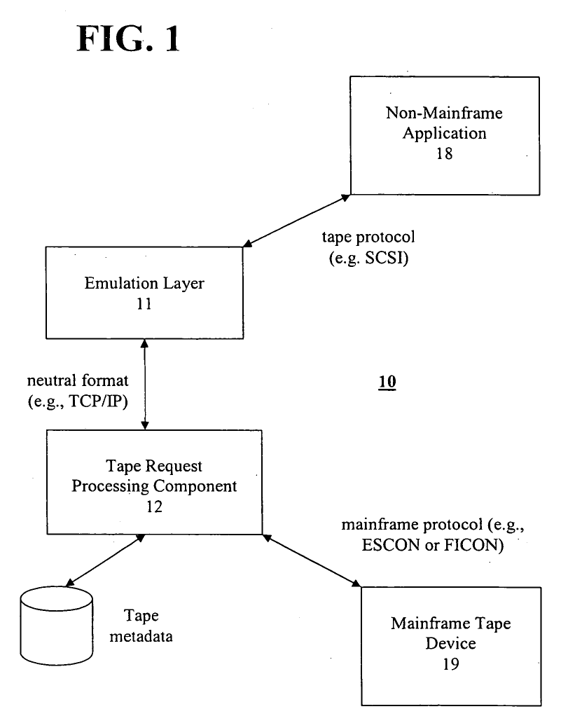

An apparatus for facilitating tape access from non-mainframe platform software applications to mainframe tape hardware, according to one embodiment, will be explained with reference to FIG. 1. Apparatus 10 includes an emulation layer 11 and a tape request processing component 12. The emulation layer 11 provides an interface to a non-mainframe application 18, and maps a tape access request in a non-mainframe format received through the interface to a neutral format. The tape request processing component 12 receives the neutral format request from the emulation layer 11, and converts the neutral format request from the emulation layer 11 to an equivalent mainframe format command for accessing a mainframe tape device 19.

The emulation layer may be a plug-in component for the non-mainframe application which allows the non-mainframe application to remain otherwise substantially unchanged.

According to another embodiment, the emulation layer is a client deployed on a non-mainframe platform, and the tape request processing component is provided as a service from a server when the neutral format request is transmitted to the server.

The tape request processing component may be a multi-threaded mainframe application, and serve a plurality of clients.

The emulation layer may emulate tape device conditions. The tape request processing component may transmit mainframe tape device status information to the emulation layer, and the emulation layer translates the mainframe tape device status information into non-mainframe format status messages.

The mainframe format command may invoke a channel program for data transfers. The mainframe format command also may invoke an operating system control function.

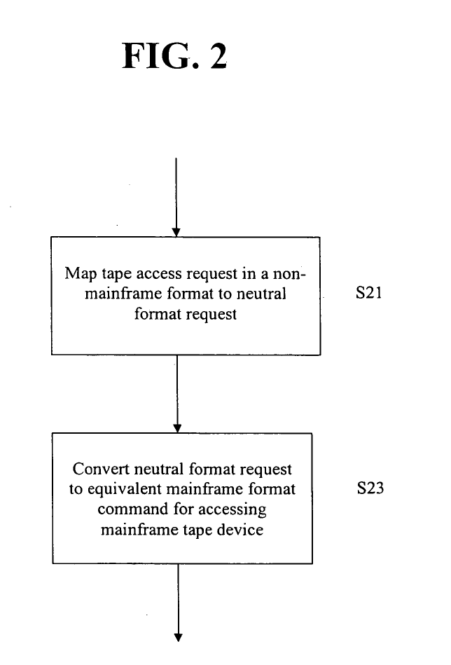

A method for facilitating tape access from non-mainframe platform software applications to mainframe tape hardware is also provided. In one embodiment (FIGS. 1 and 2), the method includes mapping through the emulation layer 11 a tape access request in a non-mainframe format from a non-mainframe application 18 to a neutral format request (step S21), and converting the neutral format request through the tape request processing component 12 to an equivalent mainframe format command for accessing a mainframe tape device 19 (step S23).

The method may further comprise emulating tape hardware conditions in a non-mainframe format.

According to another embodiment, the method may further comprise receiving mainframe tape device status information, and translating the mainframe format status information into a non-mainframe format status message.

Also, the method may further comprise mapping mainframe format error condition information regarding the tape device to a non-mainframe format status code.

The tools of the present application allow enterprises to leverage existing mainframe tape technology with tape applications that are designed to support only non-mainframe tape devices, without substantial changes to the tape applications. Having the option to use such tape applications with mainframe tape devices provides advantages in terms of cost, scalability and overall performance, and results in better integration with existing mainframe tape management applications.

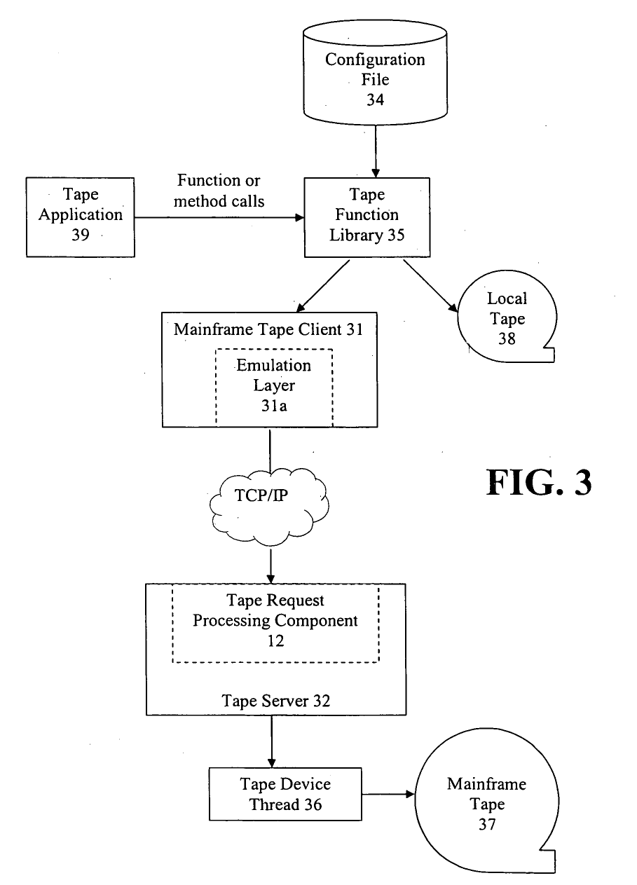

A system for facilitating tape access from non-mainframe platform tape application software to mainframe tape hardware, according to a client-server paradigm, is described below with reference to FIG. 3. It should be understood, however, that the tools of (and the claims appended to) the present application are not limited to a client-server programming model and may encompass peer-to-peer systems, message passing systems, as well as other programming models.

In addition, although exemplary embodiments are described below with reference to SCSI requests, interfaces, etc., one skilled in the art should understand after reading the present application that the tools of the present application and the claims appended to the application encompass other non-mainframe formats.

Similarly, although reference is made herein to specific IBM mainframe platforms and standard IBM mainframe formats, it should be apparent to one skilled in the art that other mainframe platforms and mainframe formats are within the scope of this application and the appended claims as well.

In a client-server embodiment, an emulation layer 31a may be provided on the side of a client 31 (that is, the computer where a tape application is running) to present a standard non-mainframe (for example, SCSI) type interface to the application. The client software 31 (for example, running on a Linux/390 platform) presents a virtual tape interface to non-mainframe tape applications 39. The interface presented on the client side permits SCSI tape applications 39 to be adapted to mainframe tape devices 37 without significant change. Thus, tape applications can run on platforms such as Linux/390 while writing and managing tapes that are actually serviced by mainframe operating systems (for example, OS/390, z/OS, etc).

For example, mainframe techniques (such as for IBM S/390 and zSeries mainframe platforms) may be integrated in tape device channel programs to support mainframe tape devices (for example, IBM 3480, 3490 and 3590 devices), without a need to update each application to specifically take advantage of these devices. From the client's perspective the client is writing to local tape devices 38, and emulation and remote access can be managed transparently. The emulation layer 31a may provide several functionalities, including for example the following: processing tape access requests in a logical SCSI format which permits a broad range of tape applications to function unchanged using the emulation technology; mapping the SCSI request to a neutral format that can be transmitted to a server (further described below); simulating tape device conditions (such as mounting/unmounting of tape volumes, creating tape labels which identify the tape volume and its owner, displaying status information, etc.) where appropriate; handling network input/output between client and server (which may be implemented as an optimized persistent TCP/IP socket pair); detecting and processing status information from the server (such as response information in the case of exceptions, or actual data in the case of tape reads); mapping errors and unusual conditions (such as communication failures, security violations, etc.) into SCSI-friendly error codes and status messages; etc.

The client emulation layer 31a may exist as a set of callable services which can be invoked by, or embedded within, higher-level applications. For example,.a set of class libraries 35 together may provide emulation of a tape device over a connection to server 32. The client may include a stand-alone shared library. The shared library approach avoids expensive additional layers of processes and corresponding data movement.

The behavior of the client may be controlled via a configuration file 34. For example, entries of the form “/dev/catape/xxxxx” direct the application to use local tape devices 38. A remote emulated tape device may be configured using “hostname:port”. syntax. Thus, a tape definition can be created under user configuration control to direct the client 31 to use, for example, remote tape access rather than a local device driver. Accordingly, tape definitions can be mixed and matched, configuring some local tape devices and some remote devices (and even some at different sites).

When a tape is opened, configuration information (stored in the configuration file 34) may be used to decide whether the tape is local or remote. If the tape is local, the code can continue on to a local tape device driver, which handles tape input/output. If the tape is remote, the client 31 can be connected to a mainframe system using a network protocol. The application 39 is generally unaware of the network redirection performed by the client.

The client 31 can request a variety of different tape access functions, including the following: mounting or dismounting a tape; querying device configuration or status; reading data from a tape; positioning a tape to a specific point on the volume; writing to a tape; control functions, such as writing tapemarks; etc.

The function requested can be encoded into a neutral format structure which is transmitted from the client 31 to the server 32. A tape request processing component 32a of the server 32 can service network requests and perform tape functions on behalf of one or more clients 31. Depending on the function, the server 32 may perform input/output to the tape device 37 using a channel program (which comprises a collection of instructions that together define a complete input/output operation on a mainframe device), or invoke an operating system function (such as OPEN or EOV) to trigger the desired processing.

According to one embodiment, the server tape request processing component 32a may be a multi-threaded application which resides on a mainframe platform (such as with an IBM z/OS or OS/390 operating system). Once initialized, the server 32 can accept network connections from one or more clients 31, and then map server function requests into low-level mainframe (for example, ESCON or FICON) tape commands. Requests involving data transfer to the tape device 37 may be handled through an appropriate device-specific channel program 36. Control functions (such as mounting tapes, etc.) may generally be triggered via calls to operating system services, which allow compatibility with various tape management applications and facilities.

The tape request processing component 32a of the server software (for example, running on OS/390 or z/OS operating systems) translates requests from each client 31 into a protocol that can be understood by mainframe (such as IBM ESCON or FICON) attached tape devices. The server 32 can accept requests from one or more clients 31 and perform equivalent functions against non-SCSI tape drives 37 common to mainframes. For example, the server 32 can uses mainframe operating system facilities for OPEN, CLOSE and EOV (End of Volume) to ensure proper integration with tape management, security and other mainframe functions. Requests to mount or dismount a particular tape can be translated into mainframe OPEN and CLOSE functions. The server may invoke the mainframe tape management system when a tape is to be scratched.

Generally, the service includes a mapping of, for example, a SCSI request from the client to the nearest equivalent function available to a mainframe attached tape drive. Mapping SCSI commands to ESCON or FICON requests, without either crippling or changing a tape application, is one component of the embodiment. A variety of emulations may also be performed in addition to SCSI-to-ESCON/FICON mapping.

Many tape applications include complex and cumbersome logic to handle tape files that span multiple tape volumes. The server preferably shields the client from tape media boundaries, seamlessly transitioning from one volume to the next without the client needing to take special action. The fact that a tape file extends across many physical tapes can be hidden from the application. The server transparently extends the file across multiple tapes, creating a single multi-volume tape dataset. The client's view is that it has a single, arbitrarily large tape file, but in reality it may span across plural tapes that are concatenated together to form a single multi-volume tape dataset on the mainframe.

Tape devices preferably are virtualized. The server can dynamically attach and free tape drives on an as-needed basis. When connections are idle, the mainframe tape device can be automatically freed and reallocated as necessary. Thus, a server with a small number of tape devices can handle the needs of a large number of clients, since the chance of many clients needing a particular tape device at the same time is generally low. Dynamic management of tape devices can use static or dynamic allocation. The connection between a particular client and a tape device is dynamic. There is no particular bond between a client and a specific tape device on the mainframe.

Where possible, built-in operating system services are invoked for tape management, in order for tape processing to appear well-behaved from the server's perspective. Preferably, the tools are adapted for a plurality of tape management applications, as well as virtual tape, tape libraries and other hardware devices that can be mainframe attached.

Buffer management and channel programs may be employed to ensure optimal utilization and performance of the tape device, with user selection of various options for buffering and input/output optimization.

User managed controls can be provided for specifying server interfaces with the operating system for tape dataset allocation requests. The user can control things such as dataset name patterns, unit and device names, etc. Therefore, the server can be easily integrated with existing tape management procedures. Facilities such as operator commands, error handling and diagnostics including a comprehensive trace facility may also be provided.

By respecting tape labels and using operating system facilities for creating and deleting tapes, tapes created by the server are protected by the end-user's tape management system, which helps to ensure that backup data is not erroneously overwritten.

Communications between the client and server preferably use TCP/IP sockets. Each client and emulated device can be accessed over a unique, persistent socket connection. Session management generally occurs on the client's side, and the protocol allows for thread per connection from the server. If the client and server are co-located on a common computer, Hypersocket protocol can be used, providing increased bandwidth between client and server.

The client can establish a network connection to the server, as defined by the configuration information, to access a tape device. The socket session may persist until the tape device is closed, or until a network or other error causes premature shutdown. Session establishment typically includes exchange of configuration data, and client and server negotiate transmission block sizes (and so forth) to ensure efficient use of network bandwidth. If multiple tape devices are configured there can be a distinct socket connection for each one.

The client can map a tape request into a network-friendly structure which is communicated using TCP/IP to the server. The structure is opaque to the application and includes all of the information that the server needs for processing the request. In general terms, the data transmitted typically includes a function verb (such as mount a tape, read, write, etc.) plus the actual data needed by the server to perform the operation. Large requests (for example, writing 64K blocks to a tape) may require fragmenting the request and reassembling the packets on the receiving side.

After processing, the server can return a similar data structure that indicates the result of the operation and any data to be presented to the application. The client can map this information into application buffers and data areas, remapping fields to be compatible with the SCSI format of the caller (for example, mainframe status information can be mapped to SCSI error codes).

During startup, a master thread can be created which performs several functions, including the following: manage new socket connections; manage communications with the operator (such as commands and requests to start/stop); create and manage threads that service individual connections and devices; etc.

Each connection can be forwarded to a thread that handles operations to a specific emulated device, which includes the following tasks: setting up and initiating requests; enforcing a security model and negotiating various parameters; allocating available devices when necessary; accessing tape devices through operating system services; handling communications and error handling; etc.

Tape information generally is sensitive data and therefore it is desirable to protect it against inadvertent disclosure or destruction. The server may provide the following security features.

Preferably, only specific users are authorized as they connect to the media server. As each client connects to a server, the server can authenticate and authorize the request. Subsequent resource checks also permit the server to control which clients can access specific tape volumes. Only permitted clients can connect to and read or write a particular tape device. Thus, a single server can safely share resources across a large number of clients, without creating security exposures that might result if clients are allowed to read or write each other's tapes.

Attempts to access tape data preferably are made in the security context of the individual user requesting the function. If the user does not have local access to the tape on the client platform, then likewise the user is not allowed to access tape data through the server.

By using operating system facilities as much as possible, the server can be well-behaved from a security point of view, such as with respect to tape volume protection.

The tools of the present application provide several benefits, including the following: allow large organizations to standardize on robust mainframe tape technologies, regardless of computing platforms involved; permit tape applications on distributed platforms (for example, SCSI-based) to be transparently redirected to a mainframe environment (which tends to be non-SCSI); provide benefits of centralized tape management regardless of platform; achieve very scalable and high performance backup and data protection solutions; allow multi-platform tape operations to be integrated with any existing tape management procedures and philosophies in use; etc.

Another benefit is that by bridging the gap between mainframe and distributed system tape, existing tape management applications can be easily extended to operate in each tape environment. For example, the tools of this disclosure allow existing tape applications that are designed to communicate with SCSI tape devices to work seanlessly with tape hardware connected to mainframe computers over a network connection.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

1. An apparatus for facilitating tape access from non-mainframe platform software applications to mainframe tape hardware, comprising:
an emulation layer adapted to provide an interface for a non-mainframe application, and map a tape access request in a non-mainframe format received through the interface to a neutral format request; and
a tape request processing component adapted to receive the neutral format request from the emulation layer, and convert the neutral format request to an equivalent mainframe format command for accessing a mainframe tape device.

2. The apparatus of claim 1, wherein the emulation layer is a plug-in component for the non-mainframe application which allows the non-mainframe application to remain otherwise substantially unchanged.

3. The apparatus of claim 1, wherein the emulation layer is a client deployed on a non-mainframe platform, and the tape request processing component is provided as a service from a server when the neutral format request is transmitted to the server.

4. The apparatus of claim 1, wherein the tape request processing component is a multi-threaded mainframe application, and serves a plurality of clients.

5. The apparatus of claim 1, wherein the emulation layer emulates tape device conditions.

6. The apparatus of claim 1, wherein the tape request processing component transmits mainframe tape device status information to the emulation layer, and the emulation layer translates the mainframe tape device status information into non-mainframe format status messages.

7. The apparatus of claim 1, wherein the mainframe format command invokes a channel program for data transfers.

8. The apparatus of claim 1, wherein the mainframe format command invokes an operating system control function.

9. A method for facilitating tape access from non-mainframe platform software applications to mainframe tape hardware, comprising:
mapping a tape access request in a non-mainframe format from a non-mainframe application through an emulation layer to a neutral format request; and
converting the neutral format request to an equivalent mainframe format command for accessing a mainframe tape device.

10. The method of claim 9, further comprising:
emulating tape hardware conditions in a non-mainframe format.

11. The method of claim 9, further comprising:
receiving mainframe tape device status information; and
translating the mainframe format status information into a non-mainframe format status message.

12. The method of claim 11, further comprising:
mapping mainframe format error condition information regarding the tape device to a non-mainframe format status code.

13. A computer system, comprising:
a processor; and
a program storage device readable by the computer system, tangibly embodying a program of instructions executable by the processor to perform the method claimed in claim 9.

14. A program storage device readable by a machine, tangibly embodying a program of instructions executable by the machine to perform the method claimed in claim 9.

15. A computer data signal transmitted in one or more segments in a transmission medium which embodies instructions executable by a computer to perform the method claimed in claim 9.
